(19) United States
(12) Patent Application Publication
(10) Pub. No.: US 2009/0157880 A1
(43) Pub. Date: Jun. 18, 2009

(54) MANAGEMENT SYSTEM FOR QUALITY OF SERVICE IN HOME NETWORK

(75) Inventors: Kwangil Lee, Daejeon (KR); Jun Hee Park, Daejeon (KR); Kyeong Deok Moon, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/334,051

(22) Filed: Dec. 12, 2008

(30) Foreign Application Priority Data
Dec. 15, 2007 (KR) 10-2007-0131823

(51) Int. Cl. G06F 15/173; G06F 17/00

(52) U.S. Cl. 709/226; 726/1

(57) ABSTRACT

There is provided a QoS (quality of service) management system in a home network. When a QoS service is provided in the home network consisting of hosts and bridges, a user provides a user identifier and authentication information and the QoS management system verifies the user identifier and authentication information when managing a user policy and providing a service, to provide a consistent and stable policy within the home network, to prevent a collision among different policies, and to prevent the home network resources from being used by an illegal user.

### CROSS-REFERENCE(S) TO RELATED APPLICATIONS

The present invention claims priority of Korean Patent Application No. 10-2007-0131823, filed on Dec. 15, 2007, which is incorporated herein by reference.

### FIELD OF THE INVENTION

The present invention relates to a QoS (quality of service) management system in a home network, and more particularly, to a QoS management system in a home network, which provides a service policy depending on a user and a service characteristic and prevents a policy collision occurring since different policies coexist within the home network.

This work was supported by the IT R&D program of MIC/IITA. [2007-S-047-01, Development of HD Class Multimedia System Technology over Wireless Home Network]

### BACKGROUND OF THE INVENTION

As the home network technologies have been developed, the multimedia services have increased to transmit not only simple text data but also audio/video data through various wire/wireless machines at home. Furthermore, as the multimedia services have increased, the relevant methods are needed to provide sufficiently wide bandwidth and different service requirements for the multimedia services in the home network.

When a user requests a service within a home network and the user selects a service policy for the requested service, a QoS (quality of service) providing system reserves required resources within the home network, depending on the selected policy, and provides the QoS for the requested service.

For example, in an UPnP (Universal Plug and Play) which is a typical home network middle ware, in order for a QoS providing system to provide QoS in a home network, a user specifies a policy holder which provides policy information for service and service requirements, and requests a QoS service to a QoS manager. The QoS manager requests a policy regarding the requested service to the policy holder. Then, the policy holder determines a policy regarding the requested service, based on service connection information, such as IP address information and TCP/UDP port information regarding the requested service, and transfers the determined policy to the QoS manager. Then, the QoS manager allocates required resources within the network, depending on the service requirements and the service policy obtained from the policy holder, and initiates the service.

In a conventional QoS providing system, when home network users use different services, the policy suitable for each user can be provided. However, when different users use the same service, there is a limit in applying different policies to individual users. Moreover, when a user requests a service by specifying an untrustful policy holder, instead of an allowed policy holder in a home network, there is no choice but to provide the service. Therefore, even though a user requests a service for which the user has a preference, it is needed to the request for the service to be accepted after determining whether it is allowable within the network or not.

### SUMMARY OF THE INVENTION

It is, therefore, an object of the present invention to provide a QoS management system in a home network, which provides a service policy depending on a user, a service characteristic and an administration policy and prevents a policy collision occurring since different policies coexist within the home network.

In accordance with a preferred embodiment of the present invention, there is provided a QoS Management system in a home network including: a user control unit allowing a user to provide a user identifier and an authentication code and to select and request an available service of the home network; a QoS management unit requesting resource allocation for a QoS service to a specific home network device, at the request for the service, after authentication using the user identifier and the authentication code; and a device control unit comparing a policy being set in the home network with a policy for the selected service, at the request for the resource allocation, verifying whether the request is admissible or not as a result of the comparison, and then providing the QoS service.

In accordance with the present invention, when providing QoS in a home network consisting of hosts and bridges, a user provides user identification and authentication information, a QoS Management system performs the certification when managing the user policy and providing the service according to the user identification and authentication information, so that the consistent and stable policy is provided within the home network and a collision among different policies is prevented. Furthermore, home network resources are prevented from being used by an illegal user.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram illustrating a QoS (quality of service) providing system in a home network, which provides QoS, depending on individual user information and service characteristics, in accordance with an embodiment of the present invention;

FIG. 2 is a specific block diagram of a user control unit illustrated in FIG. 1;

FIG. 3 is a specific block diagram of a QoS management unit illustrated in FIG. 1; and

FIG. 4 is a specific block diagram of a device control unit illustrated in FIG. 1.

### DETAILED DESCRIPTION OF THE PREFERRED EMBODIMENTS

Hereinafter, preferred embodiments of the present invention will be described in detail with reference to the accompanying drawings so that they can be readily implemented by those skilled in the art. Where the function and constitution are well-known in the relevant arts, further discussion will not be presented in the detailed description of the present invention in order not to unnecessarily make the gist of the present invention unclear.

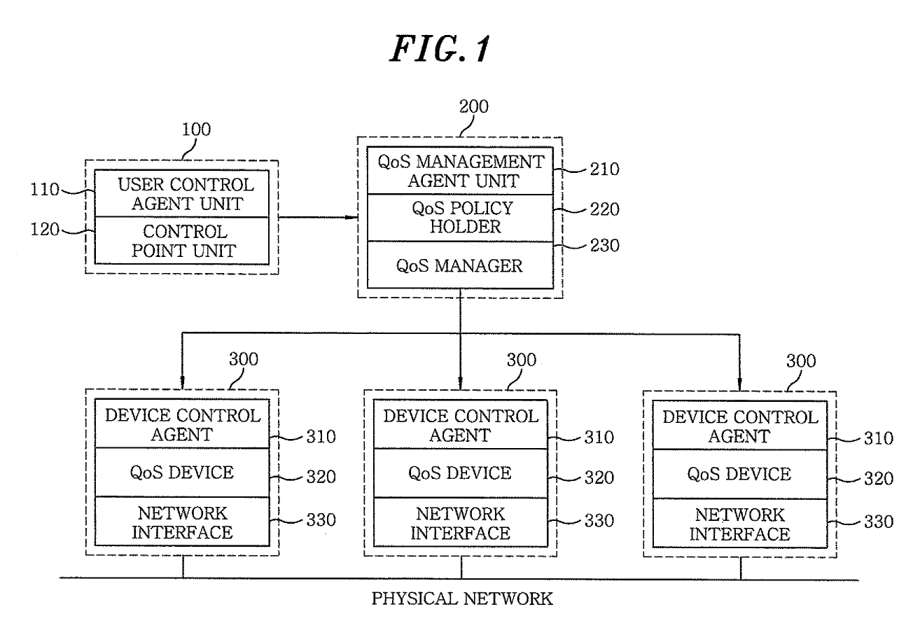

FIG. 1 is a block diagram illustrating a QoS (quality of service) providing system in a home network, which provides QoS, depending on individual user information and service characteristics, in accordance with an embodiment of the present invention.

With reference to FIG. 1, the home network comprises a user control unit 100, a QoS management unit 200, and device control units 300.

The user control unit 100 informs a user of available services, which are accessible through the home network by the user, and policy holder services, thereby allowing the user to select a desired service and to request the service.

The QoS management unit 200 performs the management of the home network. The QoS management unit 200 manages profiles of users within the home network and allocates proper priority to each individual user based on the profiles. Furthermore, the QoS management unit 200 activates or inactivates services of a QoS policy holder 220 being set by individual users. Furthermore, the QoS management unit 200 comprises a QoS manager 230 to perform functions for a QoS management of the entire home network. The QoS manager 230 performs the functions of monitoring the network traffic state and allocating the network resources. The QoS manager 230 also requests a specific home network device to allocate the resources for a QoS service. In this embodiment, the QoS manager 230 is located in the QoS management unit 200. However, the QoS manager may be located in any other device within the home network and in this case, the QoS management unit 200 comprises a unit for communicating with the QoS manager located in the home network, to verify whether or not the policy holder service is allowable to a relevant user.

Each device control unit 300 controls each home network device. When QoS regarding a service is requested through the QoS manager 230 of the home network, the device control unit 300 provides the function of a QoS device 320 to provide the QoS service through the resource allocation for the service and to transfer the information of the QoS service state to the QoS manager 230. At this time, to verify whether or not the request for the service is proper, a device control agent 310 compares a policy being set in the network with a policy of the requested service. When there is contradiction between these two policies, the device control agent 310 selects a proper policy regarding the service in consideration of priority and approves the request for the service accordingly. When the QoS service is approved in all device control units of the entire home network, along the path from the source of the service to the destination of the service, the QoS manager 230 informs of the start of the service and provides the QoS service accordingly.

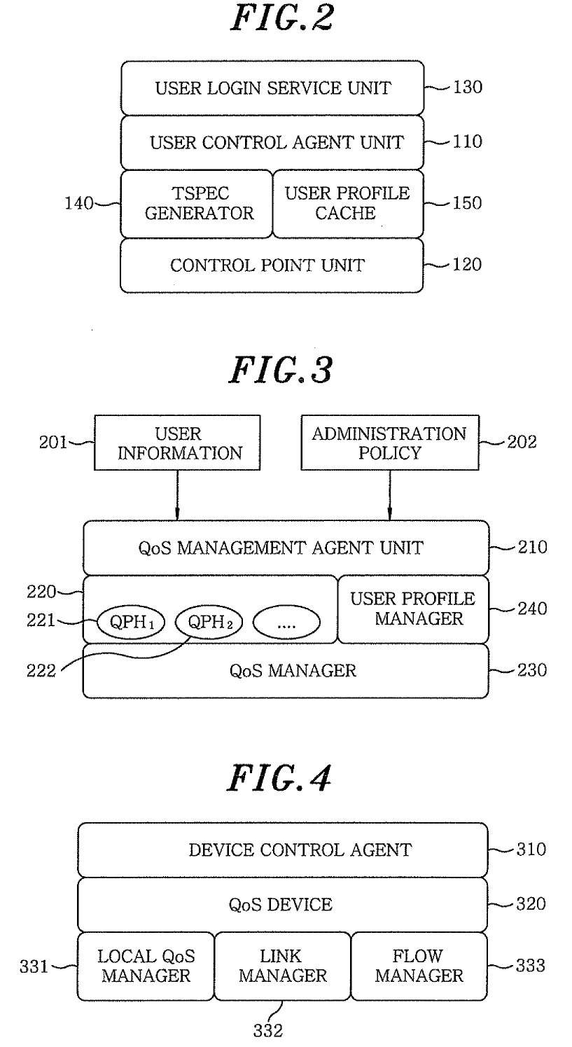

FIG. 2 is a specific block diagram illustrating the user control unit 100 in the QoS providing system in the home network which provides the QoS, depending on the individual user information and service characteristics, in accordance with an embodiment of the present invention.

The user control unit 100 comprises a user login service unit 130, a user control agent unit 110, a TSPEC generator 140, a user profile cache 150, and a control point unit 120.

The user login service unit 130 allows an individual user to use the user control unit 100 through login, so that the user can access to the home network through the user control unit 100. To this end, each user has to provide a user login identifier and a registered authentication code. When a user provides the user ID and authentication code, the user control agent unit 110 obtains user information through a corresponding password being present in the user profile cache 150 and then provides user authentication and user authority for the home network services and resources regarding the authenticated user, through information exchange with a QoS management agent unit 210.

The control point unit 120 provides user interface, thereby enabling a user to input various commands to find and control various devices. The control point unit 120 allows a user, after the user authentication is completed, to search all policy holder services which can be used by the user and to select one of the policies. The user obtains all services provided within the home network and contents information to be used for the services, through the network search.

The TSPEC generator 140 generates a QoS parameter to be used in the network, for example, a TSPEC value of the UPnP, depending on the type and form of the contents to be provided for the service.

The user control agent unit 110 requests the QoS manager 230 to provide the service, based on the generated TSPEC information, the user policy holder service information, and the user information.

When a proper policy holder service does not exist in the present home network or it needs to be changed, the user control unit 100 requests a default policy holder service to be changed, through the QoS policy holder 220. At this time, a user provides the user information.

FIG. 3 is a specific block diagram illustrating the QoS management unit in the home network and a process of setting a user policy through the QoS management unit.

A home network administrator transfers individual user information 201, which includes the registration, change and withdrawal information of a user, and administration policy information 202, which relates to an individual user's authority for the home network resources and the user's grade, to a user profile manager 240 through the QoS management agent unit 210, and stores the information thereof. The user profile manager 240 keeps and administrates all information regarding the user policy and authentication, thereby providing the information to settle a policy collision occurring among the user authentication or users. When a service policy regarding a user or the network is generated, the QoS policy holder 220 generates a QoS policy holder service instance 221 or 222 for the service policy. The generated QoS policy holder service instance 221 or 222 may be present at any place in the home network, and a policy holder service instance is selected depending on an individual user's desired policy. When a QoS service is requested, the QoS manager 230 finds the user's desired policy holder service instance and obtains a service policy regarding the policy holder service. Then, the QoS manager 230 verifies whether or not the policy holder service instance requested by the user with respect to the request for the service is the policy holder service allowed to the user. The QoS manager 230 calculates an optimum path which is proper for the user's requirements made when the user requests the service, by monitoring the resources, topology and traffic within the home network. Then, the QoS manager 230 requests resource reservation regarding the service and QoS service to all home network devices along the path.

FIG. 4 is a specific block diagram illustrating the device control unit within the home network. A process of operating home network devices including bridges, transmitters and receivers to provide home network services will be described with reference to FIG. 4.

When a service is requested through the QoS manager 230, the QoS device 320 of each home network device first determines whether or not the request for the service is proper through the device control agent 310. The device control agent 310 determines whether or not to use the resources regarding the requested service in the home network device from the user profile information, through communication with the QoS management agent unit 210. Furthermore, the device control agent 310 verifies whether or not the requested service is performed through the allowed policy holder service instance 221 or 222 and QoS manager 230. If the service is properly requested, the QoS device 320 requests the resources proper for the service to a local QoS manager 331 and performs a QoS resource reservation regarding an output network through a link manager 332. When the request for the service is set, flow information including flow identification information, QoS information regarding flow, user information, switching information, and the like, is kept in a flow manager 333. Therefore, when actual data are received, QoS regarding the service is provided based on the information administrated by the flow manager 333.

While the invention has been shown and described with respect to the preferred embodiments, it will be understood by those skilled in the art that various changes and modifications may be made without departing from the spirit and scope of the invention as defined in the following claims.

What is claimed is:

1. A QoS (quality of service) management system in a home network comprising:
a user control unit allowing a user to provide a user identifier and an authentication code and to select and request an available service of the home network;
a QoS management unit requesting resource allocation for a QoS service to a specific home network device, at the request for the service, after authentication using the user identifier and the authentication code; and
a device control unit comparing a policy being set in the home network with a policy for the selected service, at the request for the resource allocation, verifying propriety as a result of comparison, and then providing the QoS service.

2. The QoS management system of claim 1, wherein the user control unit includes a user login service unit allowing an individual user to use the user control unit by providing the user identifier and the authentication code.

3. The QoS management system of claim 1, wherein the user control unit includes a parameter generation unit generating a QoS parameter to be used in the home network, depending on the type and form of contents to be provided through the QoS service.

4. The QoS management system of claim 1, wherein the user control unit includes a user control agent unit providing authority for the QoS service, through information exchange with the QoS management unit based on the user identifier and the authentication.

5. The QoS management system of claim 1, wherein the QoS management unit includes a user profile manager receiving individual user information and administration policy information regarding an individual user's authority for the home network resources and a user's grade, which are transferred from the user control unit, and storing the individual user information and the administration policy information.

6. The QoS management system of claim 5, wherein the user profile manager keeps and manages the policy and authentication information of the individual user, when a policy collision occurs among the user authentication or users, and provides information to solve the collision.

7. The QoS management system of claim 1, wherein the QoS management unit includes:
a QoS policy holder generating a QoS policy holder service instance when a service policy for the user or network is generated; and
a QoS manager verifying whether or not the policy holder service is allowed to the user when the policy holder service instance is selected by the user control unit.

8. The QoS management system of claim 1, wherein the QoS management unit includes:
a QoS policy holder generating a QoS policy holder service instance when a service policy for the user or network is generated; and
a unit for communicating with any QoS manager being present in the home network, to verify whether or not the policy holder service is allowed to the user when the policy holder service instance is selected by the user control unit.

9. The QoS management system of claim 1, wherein the QoS management unit includes a QoS management agent unit providing authority for the QoS service, based on the user identifier and the authentication, through the information exchange with the user control unit.

10. The QoS management system of claim 1, wherein the device control unit includes a device control agent unit determining whether or not to use the resources for the QoS service, by verifying the user profile information through the communication with the QoS management unit.

11. The QoS management system of claim 10, wherein the device control agent unit verifies whether or not the request for the resource allocation is made through the allowed policy holder service instance by the QoS management unit and QoS manager, to verify the propriety.
